(19) United States
(12) Patent Application Publication
(10) Pub. No.: US 2026/0103365 A1
(43) Pub. Date: Apr. 16, 2026

(54) HOVER BLADE LIFTING SYSTEM

(71) Applicant: Stan Kanevsky, Gladwyne, PA (US)

(72) Inventor: Stan Kanevsky, Gladwyne, PA (US)

(21) Appl. No.: 19/037,429

(22) Filed: Jan. 27, 2025

Related U.S. Application Data
(60) Provisional application No. 63/625,709, filed on Jan. 26, 2024.

(51) Int. Cl. B66F 3/35

(52) U.S. Cl. CPC B66F 3/35

(57) ABSTRACT

A lifting apparatus includes an air supply conduit having an air supply end and a first air discharge end, a first blade in fluid communication with the first air discharge end, and a perforated diaphragm configured to allow air flow through the diaphragm and the blade. The diaphragm and the first blade assembly form a cavity configured to receive air from the first discharge end and discharge the air from the perforated diaphragm.

### CROSS REFERENCE TO RELATED APPLICATION

The present application claims the benefit of U.S. Provisional Patent Application Ser. No. 63/625,709, filed on Jan. 27, 2024, which is incorporated herein by reference in its entirety.

### BACKGROUND OF THE INVENTION

### Field of the Invention

The present invention relates to a hover blade lifting system apparatus.

### Description of the Related Art

Moving heavy objects, such as furniture and appliances, can be a difficult task and may risk injury to the person or persons performing the move.

It would be beneficial to provide a hover blade lift system to lift a heavy object, such as a piece of furniture or an appliance, by floating the object on a cushion of air.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, the present invention is a lifting apparatus that includes an air supply conduit having an air supply end and a first air discharge end, a first blade in fluid communication with the first air discharge end, and a perforated diaphragm configured to allow air flow through the diaphragm and the blade, forming a cavity configured to receive air from the first discharge end and discharge the air from the perforated diaphragm.

The present application further provides a lifting apparatus comprising an air supply conduit, a tee in fluid communication with the air supply conduit, and a first blade assembly in fluid communication with the tee. The first blade assembly comprises a first blade and a first perforated diaphragm disposed below the first blade. The first blade and the first perforated diaphragm form a first cavity configured to receive air from the tee through the first blade and discharge the air through the first perforated diaphragm. A second blade assembly is also in fluid communication with the tee. The second blade assembly comprises a second blade and a second perforated diaphragm disposed below the second blade. The second blade and the second perforated diaphragm form a second cavity configured to receive air from the tee through the second blade and discharge the air through the second perforated diaphragm.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 shows a perspective view of a hover blade lifting system according to a first exemplary embodiment of the present invention.

FIG. 2 shows a top perspective view of the hover blade lift system of FIG. 1.

FIG. 3 shows an exploded perspective view of the hover blade lift system of FIG. 1.

FIG. 4 shows a side elevational view of an air release valve used I the hover blade system of FIG. 1.

FIG. 4A shows a top, side, bottom, and perspective view of a variable hose adapter.

FIG. 5 shows a perspective view of a blade assembly used with the hover blade system of FIG. 1.

FIG. 6 shows an exploded perspective view of the blade assembly of FIG. 5.

FIG. 7 shows a perspective view of a hover blade lift system according to an alternative embodiment of the present invention.

FIG. 8 shows a longitudinal side view of the side of a flexible hover blade and diaphragm in a pressurized state.

FIG. 9 shows a rear view and/or front view of a flexible blade and diaphragm in a pressurized state.

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

The word “about” is used herein to include a value of +/−10 percent of the numerical value modified by the word “about” and the word “generally” is used herein to mean “without regard to particulars or exceptions.”

Additionally, the term “or” is intended to mean an inclusive “or” rather than an exclusive “or”. That is, unless specified otherwise, or clear from context, “X employs A or B”is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Additionally, the interposition of one or more additional elements may be contemplated, although not required. Additionally, for purposes of this description, the terms “link,” “connected,” “linked,” “associated,” “united,” “coupled,” “joined,” “combined,” “banded,” others not mentioned here, refer to any manner known in the art or later developed wherein any item or items are brought together into contact or association in some respect. Additionally, the interposition of one or more additional elements may be contemplated, although not required. Conversely, the terms “directly coupled,” “directly connected,” etc., imply the absence of such additional elements. Additionally, for purposes of this description, the terms “process” and “method” are used interchangeably. Alternately system may also be used interchangeably with “method” and “process”. For additional purposes of this description, the term “user,” “operator,” “customer,” “client” may be used interchangeably. For additional purposes of this description, the term “blade,” “plate,” “top plate,” “support,” others not mentioned here, may be used interchangeably, alternately or in combination in light of the present invention.

As used herein, at least one of the term connect and connectivity and connected to comprises the ability to at least one of attached to and connect with and form an air tight connection and to generally form an air tight connection and others not mentioned here.

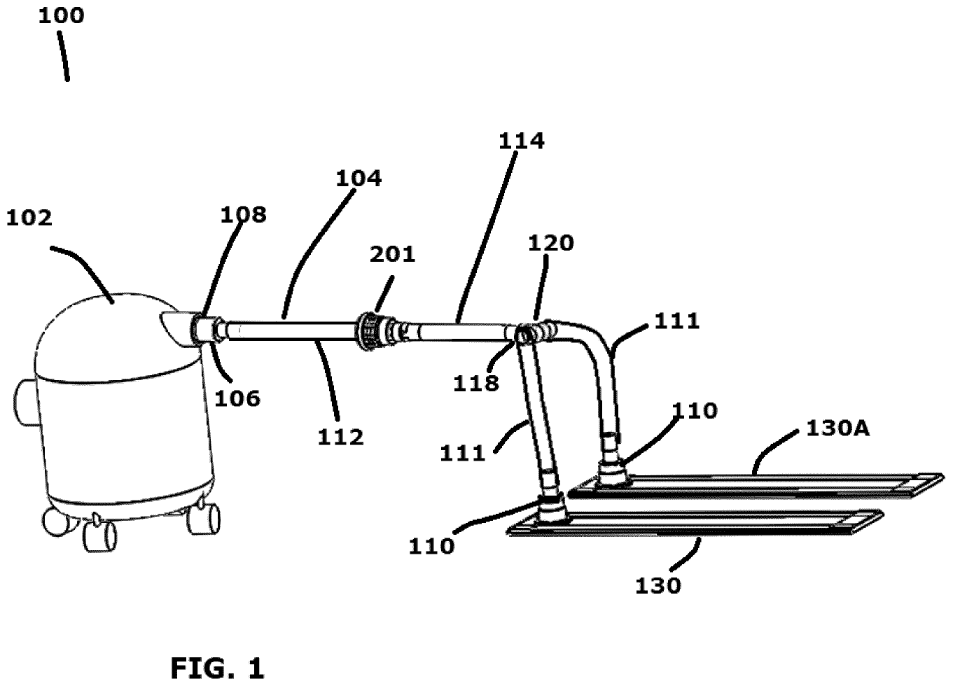

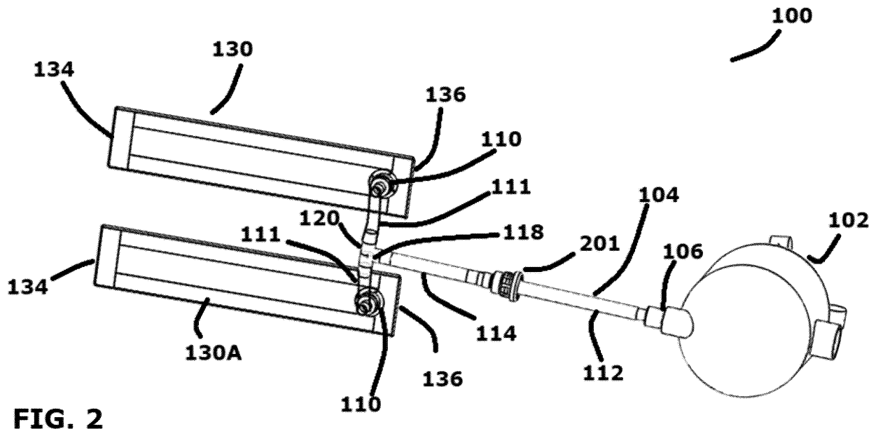

Referring to FIGS. 1-3 a hover blade lift system 100 (“system 100”) is shown. System 100 lifts an object, such as a piece of furniture (not shown), off the ground using air pressure discharged from beneath a pair of blade assemblies 130, 130A, making it much easier to move the object.

System 100 includes an air supply, such as a blower 102, releasably coupled to blade assemblies 130, 130A. Blower 102 can be shop-vac. Optionally, blade assembly 130A can be omitted and only a single blade assembly 130 can be used. In an exemplary embodiment, blade assemblies 130, 130A are identical to each other, so only one blade assembly 130 will be described.

While blower 102 is shown, those skilled in the art will recognize that other pressurized air sources, such as an air compressor (not shown), an air accumulator (not shown), or any other known or as yet unknown structure or means for providing pressurized air to blade assemblies 130, 130A can be used.

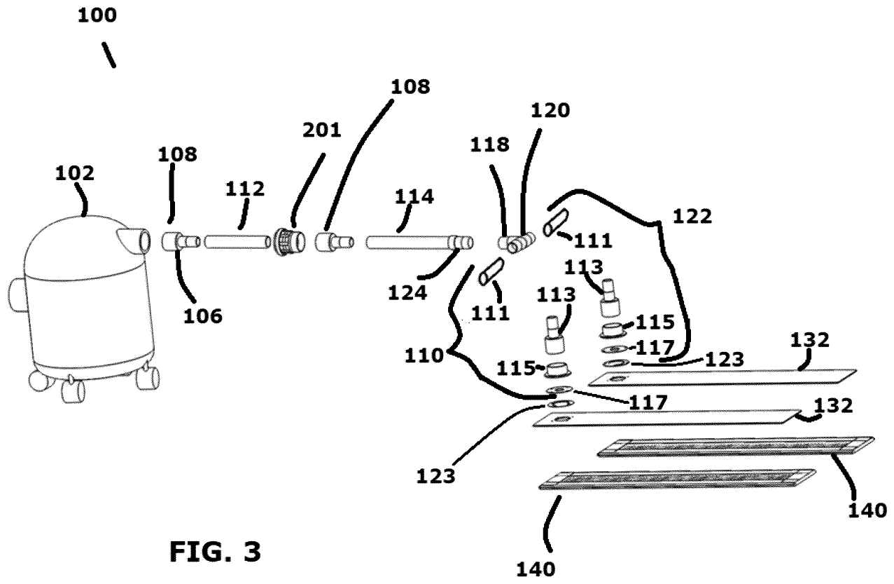

An air supply conduit 104 has an air supply end 106 releasably coupled to blower 102 via a hose adapter 108. Air supply conduit 104 also has a first air discharge end 110 that is connected to blade assembly 130. As shown in FIG. 3, discharge end 110 can include a hose 111, a hose adapter 113, a flange 115, and a flange gasket 117. Optionally, air supply conduit 104 can also include a plurality of flexible tubes or hoses 112, 114, connected to each other vias couplings or adapters 201, 118.

First blade assembly 130 is in fluid communication with first air discharge end 110 via hoses 112, 114, couplings and adapters 108, 201, 118. For a two blade assembly system, a tee 120 is also in fluid communication with air supply conduit 104 and can be located between adapter 118 and first air discharge end 110. Referring FIG. 1-3, if tee 120 is employed, a second air discharge end 122 is attached to tee 120 and provides for fluid communication between air supply conduit 104 and second blade assembly 130A such that second blade assembly 130A is in fluid communication with air supply 102 via second discharge end 122.

In an exemplary embodiment, air supply conduit 104 can be at least one of a hose and a tube and a vacuum hose and pressurize-able hose for the purpose of carrying lightly pressurized air in the range of 0.1 inches water column to 10 pounds of pressure per square inch (PSI). Though pressures ranges may be described exemplarily herein for the present embodiment, this does not limit the current invention to these ranges for the present invention. Additionally, the diameter of air supply conduit 104 can range from such as ½ inch through 3 inches in diameter. Though size ranges are exemplarily described in this paragraph for illustration, this language does not limit the current invention to these sizes and or size ranges.

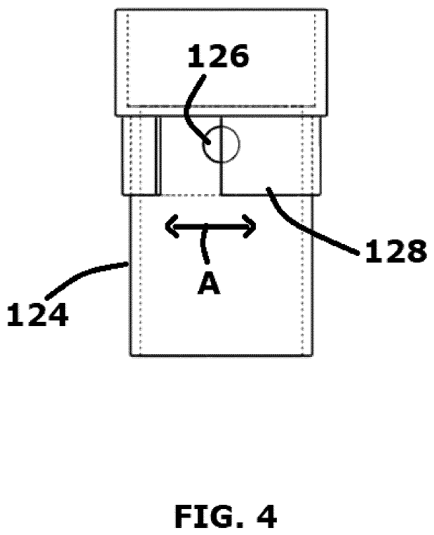

A first check valve 123 is disposed between air supply end 110 and first blade 130. Check valve 123 prevents air from air supply 102 from backing up and forces the air from air supply 102 into blade assembly 130 for discharge. First discharge end 110 includes a connector air release valve 124, shown in FIG. 4. Connector air release valve 124 includes an air release outlet 126 and a sleeve 128 that is configured to selectively open and close, or cover the air release outlet 126 to modulate air entering into blade assembly 130. Sleeve 128 can be rotated about valve 124 in the direction of arrow “A” to expose air release outlet 126 and allow a predetermined amount of air to be released from air supply conduit 104. Such air release can be selectively modulated depending on the weight of the user or the height above ground that the user desires blade assembly 130 to go.

Referring FIG. 4A, adapter 201 is a universal and/or variable adapter with top through-hole 202, top 204, outer surface 203, variable diameter 206, mating surface 208, bottom 207, outer surface 203A, outer surface 205 in this exemplary embodiment as shown herein. The term through-hole describes at least one of a passageway and a passageway from one end to the other end of adapter 201 and an open and/or common cavity and others not mentioned here. In the current exemplary embodiment, universal adapter 201 can modulate to increase and/or decrease at least one of variable diameter 206 and mating surface 208 to adaptably receive and connect and properly mate with different and/or varying diameter tube and/or hose sizes, such as hose 112 of FIG. 1-3, ranging from approximately ½ inch through 3 inches in diameter. Though size ranges are exemplarily described in this paragraph for illustration, this language does not limit the current invention to these sizes and or size ranges.

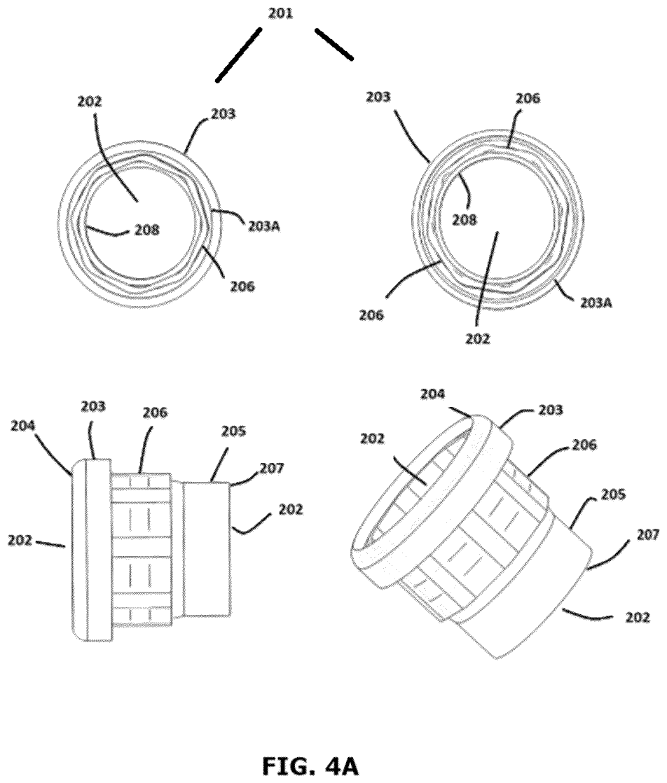

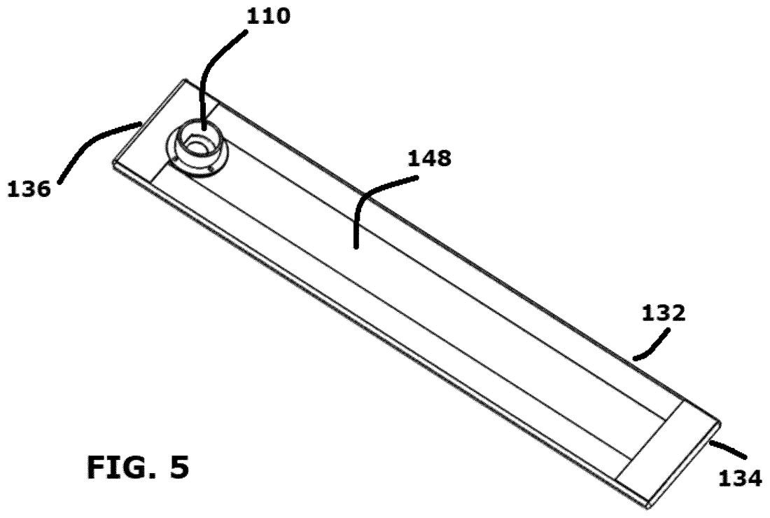

Referring to FIGS. 5 and 6, blade assembly 130 includes a blade 132 that serves as a foot pad for the user. Blade 130 can be rectangular, oblong, oval, round, square, or any other desired shape. In an exemplary embodiment, blade 132 is a rectangle, having a width that may range between 5 and 20 inches, such as at least one of 7 and 9 and 10 and 12 inches and between 20 and 60 inches length, such as at least one of 24 and 30 and 36 and 40 and 48 inches, illustratively in this exemplary embodiment. Blade 132 may be comprised of at least one of a rigid material and a semi-rigid material and a flexible material.

Blade assembly 130 also includes a front end portion 134 and a rear end portion 136. First air discharge end 110 is located at the rear end portion 136. Blade assembly 130 further includes a perforated diaphragm 140 that is configured to allow air flow through the diaphragm 140 and the blade assembly 130. In an exemplary embodiment, the number and/or quantity of perforations 142 in perforated diaphragm 140 may range between 509 and 6,114.

A plurality of flaps 144, 146 are attached to the perforated diaphragm 140. The plurality of flaps 144, 146 include side flaps 144 and front/rear flaps 146. Flaps 144, 146 are directly connected to the blade 132. Flaps 144, 146, along with diaphragm 140 and the blade 132 form a cavity 148 that is configured to receive air from the discharge end 110 and discharge the air from the perforated diaphragm 140.

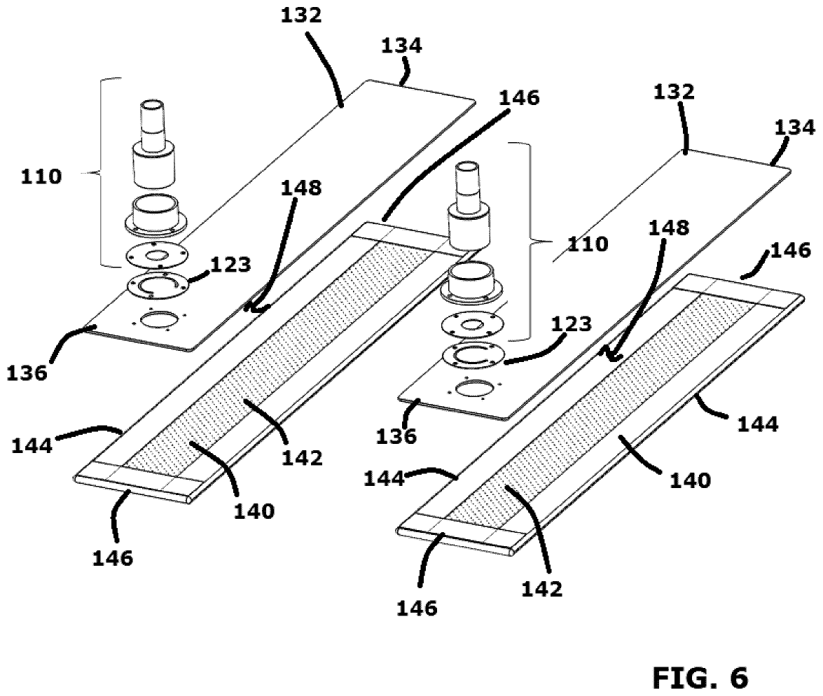

Referring FIG. 7, an optional stabilizer bar 160 is shown in use releasably connecting the first blade assembly 130 to the second blade assembly 130A to allow any user of system 100 to insert both blade assemblies 130, 130A under an object to be moved simultaneously. Stabilizer bar 160 is located proximate to the first air discharge end 110 at rear end portion 136 of blade 132.

In use, a user (not shown) places blade assembly 130 underneath a front or side of an object to be moved and blade assembly 130A under the rear or opposite side of the object to be moved. The user turns on air supply 102 such that air flows through air supply conduit 104 to blade assemblies 130, 130A. The air exits blade assemblies 130, 130A via perforations 142 in diaphragm 140 with sufficient force to lift blade assemblies 130, 130A, as well as the object, off the ground. If the lift is too great, the user can modulate the amount of air being directed to blade assemblies 130, 130A by rotating sleeve 128 on connector air release valve 124 to direct some of the air out of air release outlet 126 and away from blade assemblies 130, 130A. When the object is at a desired height from the ground 130, 130A, the user can move the object from its present location to a desired location on a bed of air, making the object much easier to move. When the object is at its desired location, the user can turn off the air supply 102.

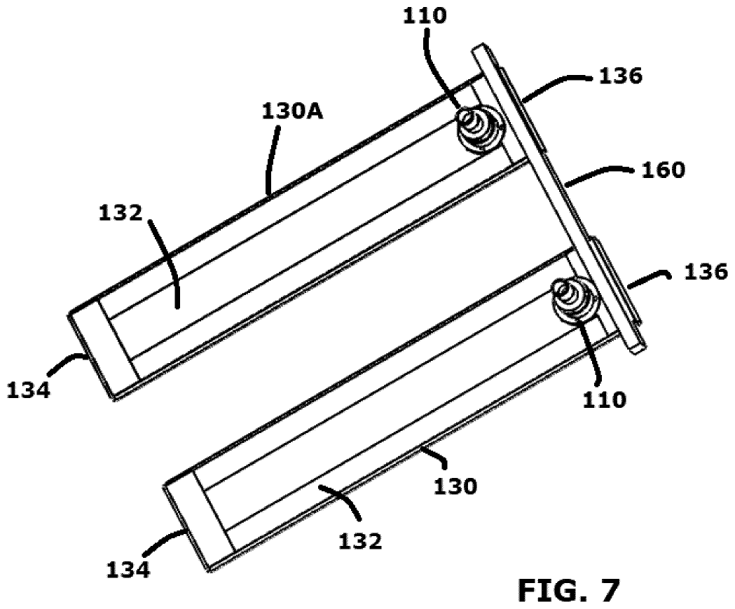

In the instance blade 132 is comprised of a flexible material, the flexible material of blade 132 can at least one of flexibly balloon and/or bow. Referring FIG. 8, a longitudinal (long-ways, lengthwise) side view of a flexible blade 132 is shown with blade 132 in a ballooned state. Position “E” in this figure represents the original location of blade 132 prior to pressurizing apparatus 100, and distance “C” representing the ballooning distance “C” which blade 132 has expanded to with Apparatus 100 in a pressurized state. Dimension “B” illustrates the expansion of diaphragm 140 in FIG. 8. Dimension “D” illustrates the combined ballooning and/or displacement of both blade 132 and diaphragm 140 with apparatus 100 in an active pressurized state.

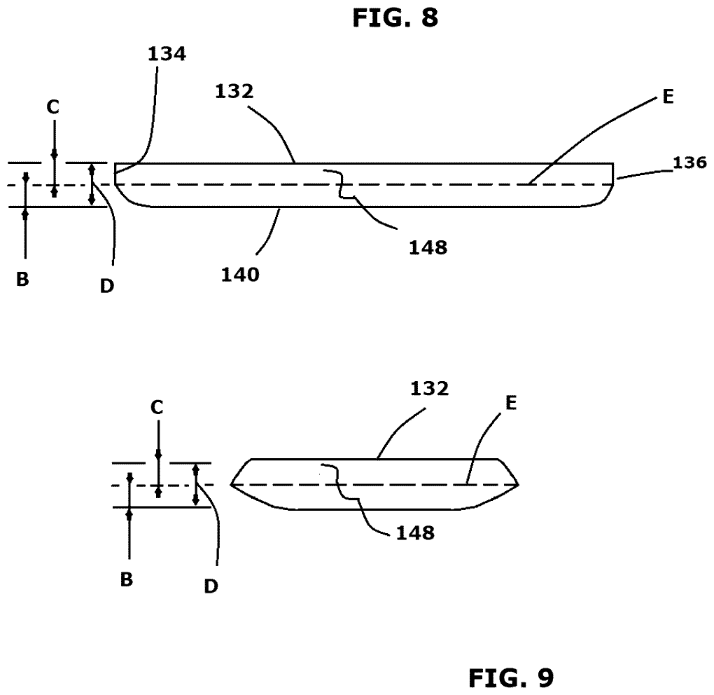

Referring FIG. 9, a side view showing the width of a flexible blade 132 illustrates blade 132 in a ballooned state. Position “E” in this figure represents the original location of blade 132 prior to pressurizing apparatus 100, and distance “C” representing the ballooning distance “C” which blade 132 has expanded to with Apparatus 100 in a pressurized state. Dimension “B” illustrates the expansion of diaphragm 140 in FIG. 8. Dimension “D” illustrates the combined ballooning and/or displacement of both blade 132 and diaphragm 140 with apparatus 100 in an active pressurized state.

It will be further understood that various changes in the details, materials, and arrangements of the parts which have been described and illustrated in order to explain the nature of this invention may be made by those skilled in the art without departing from the scope of the invention as expressed in the following claims.

I claim:

1. A lifting apparatus comprising:
an air supply conduit having an air supply end and a first air discharge end;
a first blade assembly in fluid communication with the first air discharge end; and
a perforated diaphragm configured to allow air flow through the diaphragm and the blade assembly, the diaphragm and the first blade assembly forming a cavity configured to receive air from the first discharge end and discharge the air from the perforated diaphragm.

2. The lifting apparatus according to claim 1, further comprising a second blade assembly in fluid communication with the air supply.

3. The lifting apparatus according to claim 2, wherein the air supply further comprises a second discharge end, wherein the second blade is in fluid communication with the second discharge end.

4. The lifting apparatus according to claim 3, further comprising a variable adapter which can modulate diameter to at least one of receive and connect and mate with different tubing sizes.

5. The lifting apparatus according to claim 4, further comprising a stabilizer bar connecting the first blade assembly to the second blade assembly.

6. The lifting apparatus according to claim 5, wherein the stabilizer bar is located proximate to the first air discharge end.

7. The lifting apparatus according to claim 6, further comprising a first check valve disposed between the air supply end and the first blade.

8. The lifting apparatus according to claim 1, wherein the first blade assembly comprises a front end portion and a rear end portion, wherein the first air discharge end is located at the rear end portion.

9. The lifting apparatus according to claim 1, wherein the air supply conduit is releasably connectable to an air source.

10. The lifting apparatus according to claim 7, wherein the air source comprises an air blower.

11. The lifting apparatus according to claim 1, wherein the first discharge end comprises a connector valve.

12. The lifting apparatus according to claim 10, wherein the connector valve comprises a sleeve configured to selectively open and close the connector valve.

13. The lifting apparatus of claim 12, wherein the blade is made of flexible material which balloons when the lifting apparatus is pressurized.

14. A lifting apparatus comprising:
an air supply conduit;
a tee in fluid communication with the air supply conduit;
a first blade assembly in fluid communication with the tee, the first blade assembly comprising:
a first blade; and
a first perforated diaphragm disposed below the first blade, the first blade and the first perforated diaphragm forming a first cavity configured to receive air from the tee through the first blade and discharge the air through the first perforated diaphragm; and
a second blade assembly in fluid communication with the tee, the second blade assembly comprising:
a second blade; and
a second perforated diaphragm disposed below the second blade, the second blade and the second perforated diaphragm forming a second cavity configured to receive air from the tee through the second blade and discharge the air through the second perforated diaphragm.

15. The lifting apparatus according to claim 14, further comprising a first flexible conduit located between the tee and the first blade assembly and a second flexible conduit located between the tee and the second blade assembly.

16. The lifting apparatus according to claim 15, further comprising a first check valve between the first flexible conduit and the first blade and a second check valve between the second flexible conduit and the second blade.

17. The lifting apparatus according to claim 16, further comprising a stabilizer bar connecting the first blade to the second blade.

18. The lifting apparatus according to claim 17, wherein the first blade assembly further comprises a first perforated diaphragm attached to the blade, forming a cavity between the first blade and the first perforated diaphragm.

19. The lifting assembly according to claim 18, further comprising a plurality of flaps attached to the perforated diaphragm, the plurality of flaps being directly connected to the first blade.

20. The lifting assembly according to claim 19, wherein the air supply conduit comprises an air release valve.

21. The lifting assembly according to claim 20, wherein the air release valve comprises an air release outlet and a sleeve configured to selectively cover the air release outlet.

22. The lifting assembly according to claim 21, further comprising a variable adapter which can modulate diameter to at least one of receive and connect and mate with varying tube diameters.

23. The lifting apparatus of claim 22, wherein the blade is made of flexible material which balloons when the lifting apparatus is pressurized.

24. The lifting assembly according to claim 23, further comprising a blower connected to the air supply conduit.
